(19) United States
(12) Patent Application Publication
(10) Pub. No.: US 2022/0324625 A1
(43) Pub. Date: Oct. 13, 2022

(54) SUSTAINABLE BIODEGRADABLE PROTECTIVE PACKAGING SYSTEMS PRODUCED FROM AGRICULTURAL PRODUCTS

(71) Applicants: Porter BOWEN, Miami, FL (US); Victoria HAGENLOCKER, Miami, FL (US); Alejandro ANTORCHA, Miami, FL (US); Sabrina SHARMA, Miami, FL (US); Daniel HAGENLOCKER, Miami, FL (US)

(72) Inventors: Porter BOWEN, Miami, FL (US); Victoria HAGENLOCKER, Miami, FL (US); Alejandro ANTORCHA, Miami, FL (US); Sabrina SHARMA, Miami, FL (US); Daniel HAGENLOCKER, Miami, FL (US)

(21) Appl. No.: 17/470,130

(22) Filed: Sep. 9, 2021

Related U.S. Application Data
(60) Provisional application No. 63/173,492, filed on Apr. 11, 2021.

(51) Int. Cl. B65D 65/46; B65D 81/05; D21B 1/34; D21H 27/10; D21H 27/36

(52) U.S. Cl. CPC B65D 65/466; B65D 81/058; D21B 1/345; D21H 27/10; D21H 27/36

(57) ABSTRACT

Provided is a wheat straw paper composite for a packaging material, comprising a first layer and second layer of wheat straw paper; and a layer of wheat flour film therebetween. Also provided is a laminate comprising at least three of the wheat straw paper composites, the first and second wheat straw paper composites in the form of a flat sheet, and the third wheat straw paper composite corrugated to include a plurality of flutes and positioned between the first and second wheat straw paper composite. Also provided is a system for packaging and physically protecting electronic devices in transit. The packaging system includes the laminate provided herein as an external protection container in combination with a corn foam insert that comprises a biodegradable cornstarch foam product comprising at least 60 wt % cornstarch, or a biodegradable expanded foam comprising a polylactic acid.

### CROSS-REFERENCE TO RELATED APPLICATIONS

This application claims priority to and the benefit of U.S. Provisional Patent Application No. 63/173,492, filed on Apr. 11, 2021, the disclosure of which is incorporated herein in its entirety by reference.

### FIELD OF THE INVENTION

This invention relates to a system for packaging and physically protecting electronic devices in transit; specifically, the packaging and protection of laptop computers. Particularly, the invention provides encapsulation for an electronic device precisely designed to withstand the pressure of transit, whether that be by ground, air, or sea transportation. Types of transportation include but are not limited to trucks, large cargo ships, planes, or small carrier ships. The invention is also applicable in packaging and physically protecting alternate electronic devices such as tablets, smartphones, and desktop computers.

### BACKGROUND

Conventional packaging for shipping containers have usually included conventional cardboard box type shipping containers containing a material for protecting the item to be shipped, such as loose fill Styrofoam packing peanuts, or plastic cushions filled with air (such as bubble wrap or plastic air bags), or panels or cradles made of an insulating material, such as expanded polystyrene formed into a desired shape to accommodate the item and hold it in place within the cardboard box. While expanded polystyrene can provide shock absorbent properties, expanded polystyrene is a relatively expensive insulating material that is not biodegradable.

Conventional cardboard box type shipping containers apply unnecessary stress to the timber industry. Conventional corrugated cardboard boxes require over one hundred million trees to sustain their industry annually. Furthermore, the corrugated cardboard overwhelms recycling plants and ends up in landfills. Although an approximated 10 percent of cardboard is not recycled, 10 percent of 16 billion is still a significant 1.6 billion cardboard boxes stacking up in various landfills across the United States. Accounting for the loss of millions of trees each year, cardboard floods landfills and overwhelms recycling plants, yet it is not sustainable.

Additionally, securing items to be shipped within the corrugated cardboard boxes requires additional packaging material (such as packing paper, plastic bubble wrap, or polystyrene foam), which is not biodegradable. The paper stresses the lumber industry further, and the plastic or polystyrene foam can end up polluting oceans or overburdening landfills.

Due to these environmental concerns, there have been many proposed replacements for polystyrene products and plastics that are environmentally friendly biodegradable materials. While wood pulp-based products have made some inroads, the tremendous amount of energy that is required to produce it and the cumulative effect it can have on deforestation requires an alternative to wood pulp-based products.

Alternate packaging material has been developed, yet none manages to reach the sustained widespread and inexpensive availability that the current corrugated cardboard box has accomplished. Some of these alternate packaging materials use cardboards that utilize niche materials like mushrooms (Sumerlin, “Making Mushroom Paper,” 2013), a material that requires completely new infrastructure to scale. Other alternatives replace the polystyrene foam using seaweed (Keating, “How Feasible Is Using Seaweed as Packaging?”, 2019), or other plants, which requires new industries to gather a sustainable and scalable amount of material.

Biodegradable paper laminates that include traditional paper stock laminated to a polymeric film that is made from a biodegradable polymeric material such as a polylactide or a biodegradable polyolefin are known in the art (Chase et al., US Pat. App. Pub. No. US20090096703 (2009)). Such papers are designed to be tear resistant and to provide electromagnetic shielding to be used as a protective sleeve, sheath, holder, wallpaper, RFID machine-readable cards, or lining in traditional packaging.

Biodegradable composite material of starch and wood fibers or wood flour has been developed for use in packaging (see Bowden et al., U.S. Pat. No. 6,878,199 (2005); Meeuwsen, PCT Publication No. WO 99/02598 (1999); Kesselring et al., US Pat. App. Pub. No. 2002/0108532 (2002); and Andersen et al., U.S. Pat. No. 5,736,209 (1998)), but these composites rely on wood-derived products from trees.

It is apparent that there exists a need for eco-friendly alternatives to the corrugated cardboard box and the conventional packaging materials contained therein, each having a production process that is relatively similar to conventional processes that can be implemented using the existing developed infrastructures of the industry and conventional equipment or requiring only minimal alterations thereof. The alternative must also be able to biodegradable and yet exhibit functional properties that are least similar to conventional products, and possess the same or similar durability.

### SUMMARY

The present invention is directed toward providing such alternatives. The present invention overcomes the foregoing and other shortcomings and drawbacks of shipping containers heretofore known.

Provided is a packaging system that is a combination of a shipping container made of agricultural waste biomass and inserts made of biodegradable materials as an integrated solution to the wood-based and non-degradable plastic materials found in the industry for packaging applications.

While the invention will be described in connection with certain embodiments, it will be understood that the invention is not limited to these embodiments. On the contrary, the invention includes all alternatives, modifications and equivalents as may be included within the spirit and scope of the present invention.

In accordance with the principles of the present invention, a shipping container is provided for shipping fragile items, such as electronic equipment, particularly electronic devices, for example. The shipping container is particularly designed to provide shock absorbing protection to the electronic equipment received therein during transport and handling of the container.

The present invention describes a durable package that simultaneously aids the environment and successfully protects its housed electronic items during shipping and handling. Sustainable ingredients and procedures are provided, and these have the scalability and processability similar to conventional corrugated cardboard manufacturing.

Provided is a wheat straw paper composite for a packaging material. The wheat straw paper composite includes a first layer of wheat straw paper; a layer of wheat flour film in contact with a surface of the first layer of wheat straw paper; and a second layer of wheat straw paper in contact with a surface of the wheat flour film opposite of the surface of the layer of wheat flour film in contact with the first layer of wheat straw paper. The aqueous solution used to form the wheat flour film can include an amount of wheat flour from about 5 wt % to about 15 wt % based on the total weight of the aqueous solution. The wheat straw paper can include bleached wheat straw fiber, unbleached wheat straw fiber, or a combination thereof.

The wheat straw paper used in the composite can be or include mechanically refined wheat straw fiber. The wheat straw paper used in the composite can be or include defibrillated wheat straw fiber. The wheat straw paper can include at least 80 wt % virgin wheat straw fiber. The wheat straw paper can include up to 20 wt % agricultural fiber selected from among abaca, bamboo, corn husk fiber, corn stalk fiber, cotton, flax, hemp, jute, kenaf, rice straw fiber, recycled wheat straw fiber, sisal fiber, sugarcane bagasse fiber, and combinations thereof. The wheat straw paper comprises a nitrogen-containing compound or a phosphorous-containing compound as an additive. Such an additive can promote microorganism growth during biodegradation of the wheat straw paper. The wheat straw paper can include an additive selected from among a filler, a fire retardant, an impact modifier, a plasticizer, a processing aid, a UV stabilizer, a mineral particle for hardness, and combinations thereof. The wheat straw paper can have a basis weight of from about 75 g/m² to 450 g/m².

In the wheat straw paper composites provided herein, the wheat flour film is a dried aqueous solution containing a gelatinized wheat flour. The wheat flour can be or include a hard wheat flour, a weak wheat flour, or a combination thereof. The wheat flour can include at least 8 wt % total protein. The wheat flour can include from about 8 wt % to about 15 wt % total protein. The wheat flour can include from about 1 to 4 wt % gliadins. The wheat flour can include from about 4 to 6 wt % gluten ins. The wheat flour can be selected so that when the wheat flour is moistened or exposed to an aqueous solution and subjected to shear energy, the amount of gluten produced by the wheat flour is from about 8 to 13 wt %.

Also provided is a packaging system. The packaging system can include a combination of an external protection container and a corn foam insulation insert. The external protection container can include a laminate that includes at least three wheat straw paper composites described above. The first wheat straw paper composite is in the form of a flat sheet, the second wheat straw paper composite is in the form of a flat sheet, and the third wheat straw paper composite is in the form of a corrugated sheet corrugated to include a plurality of flutes and having a first surface and a second surface. The corn foam insert can include a biodegradable cornstarch foam product comprising at least 60 wt % cornstarch, or a biodegradable expanded foam comprising a polylactic acid (PLA), or a combination thereof. In the packaging system, a first layer of a biodegradable adhesive can be included between the first surface of the corrugated sheet and the first wheat straw paper composite. A second layer of a biodegradable adhesive can be included between the second surface of the corrugated sheet and the second wheat straw paper composite. In the packaging system, when a first and second layer of biodegradable adhesive are present, the biodegradable adhesive in the first layer and the second layer can be the same, or the biodegradable adhesive in the first layer can be different from the biodegradable adhesive in the second layer. The packaging system provided herein also can include a first wheat flour film between the first surface of the corrugated sheet and a surface of the first wheat straw paper composite, and a second wheat flour film between the second surface of the corrugated sheet and a surface of the second wheat straw paper composite;

In the packaging system provided herein, the biodegradable cornstarch foam product can be an extruded product comprising at least 90 wt % cornstarch. The cornstarch can be a high amylose cornstarch (45% or higher amylose) or a high amylopectin cornstarch (45% or higher amylopectin). The cornstarch of the biodegradable cornstarch foam product can be a modified cornstarch. The modified cornstarch can be selected from among an acid treated starch, an enzymatically modified starch, an alkali treated starch, a dextrinized starch, a hydroxymethylated starch, a hydroxyethylated starch, a hydroxypropylated starch, an octenyl succinic anhydride modified starch, a starch acetate, a starch phosphate, an oxidized starch, an acetylated oxidized starch, and combinations thereof. The cornstarch of the biodegradable cornstarch foam product can be a high amylose modified starch. The cornstarch of the biodegradable cornstarch foam product can be a high amylopectin modified starch.

In the packaging system provided herein, the corn foam insert can include an additive. The additive can be selected from among glycerol, a dibasic acid, an acid anhydride, a poly(hydroxyl amino ether), a poly(hydroxyl ether), a poly(caprolactone), a cellulose acetate, and combinations thereof. The corn foam insert can include a poly(hydroxyl amino ether). The corn foam insert can include a poly(hydroxyl amino ether). The corn foam insert can include a poly(caprolactone). The corn foam insert can include a cellulose acetate. The biodegradable cornstarch foam product can have a medium density, closed cell structure.

In the packaging system provided herein, the corn foam insert can be coated with a biodegradable coating. The biodegradable coating can reduce frictional properties of the insert and result in the minimization or elimination of sanding and dust creation. The biodegradable coating can be a water-soluble polyvinyl alcohol. The water-soluble polyvinyl alcohol is biodegradable and can have minimal to no impact on dissolution of the foam when exposed to water or on biodegradability of the corn foam insert.

The packaging system provided herein contains materials composed of fully biodegradable materials, which can be sourced from agricultural waste. The packaging system provided herein can protect an electronic device contained therein from a fall of up to 36 inches. At least one embodiment demonstrated protection of the electronic device contained therein from a fall from over 10 feet. The packaging system provided herein has a shelf life of equivalent length to conventional wood-based cardboard and acts as a financially viable alternative to the current corrugated cardboard. The packaging system provided herein has enough compressive strength to be stacked, either in a non-folded orientation or during shipment while encasing products.

Also provided is a method for forming a laminate structure containing the wheat straw paper. The method includes providing a first wheat straw paper layer, coating at least one surface of the first wheat straw paper layer with an aqueous solution comprising a gelatinized wheat flour to form a wheat flour layer, and contacting the wheat flour layer with a second wheat straw paper layer. The aqueous solution comprising a gelatinized wheat flour can at least partially impregnate a surface of the first wheat straw paper and the second wheat straw paper. The method further comprises drying the laminate, whereby the wheat flour layer forms a wheat flour film.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. These drawings are merely schematic representations based on convenience and the ease of demonstrating the present disclosure, and are, therefore, not intended to indicate relative size and dimensions of the devices or components thereof and/or to define or limit the scope of the exemplary embodiments. The drawings, by no means, limit the scope, shape, or orientation the invention can assume.

In the drawings:

FIG. 1 is an illustration of one exemplary orientation of the packaging system provided herein, showing the corn foam insulation integrated within the external protection container made of a laminate in the form of a corrugated wheat fiber laminate.

FIGS. 2A and 2B show illustrations of an exploded view of an exemplary embodiment of the packaging system viewed from different perspectives. The figures show corn foam insulation inserts at each end of an electronic device, cradling the electronic device, that when inserted within the external protection container, provides air spaces around the electronic device so that it is separate and apart from the external protection container and is not in contact with any surface of the external protection container.

FIG. 3A shows an illustration of a perspective view of an exemplary embodiment of the packaging system with the lid of the external protection container open to show the inside of the external protection container containing the corn foam insulation inserts at each end of the electronic device cradling the electronic device.

FIG. 3B shows an illustration of a top view of the inside of the external protection container containing the corn foam insulation inserts at each end of the electronic device showing the air spaces that surround the electronic device so that the electronic device does not come into contact with any surface of the external protection container.

FIG. 4 is an illustration of a cross-sectional side view of an exemplary composite that includes two layers of wheat straw paper and a layer of wheat flour film therebetween.

FIGS. 5A and 5B are illustrations of a cross-sectional perspective view of a section of an exemplary laminate that includes three components: a first wheat straw paper composite and a second wheat straw paper composite provided as flat sheets, and in between these flat sheets a corrugated wheat straw paper composite.

FIG. 6 is an illustration of a perspective view of an exemplary external protection container, depicted in the configuration of an open tray form container.

FIG. 7A is a partial cross-sectional side profile view of an example of the packaging system that includes an external protection container made of a laminate in the form of a corrugated wheat fiber cardboard as a base, and within the external protection container a corn foam insulation insert.

FIG. 7B is a partial cross-sectional perspective view of an example of the packaging system that includes an external protection container made of a laminate in the form of a corrugated wheat fiber laminate as a base, and within the external protection container a corn foam insulation insert, illustrating the voids in the corn foam insulation.

FIGS. 8A through 8H show illustrations of an exemplary corn foam insulation insert for protecting an electronic device to be shipped.

FIGS. 9A and 9B show illustrations of another exemplary embodiment of the packaging system, which includes two modular expanded foam pieces, each containing a cavity forming a cradle in which the electronic device (a laptop is depicted) is supported. In FIG. 9A, a perspective view shows the electronic device inserted into a cavity of each piece of the modular expanded foam pieces.

FIG. 9B is a perspective view showing the electronic equipment cradled in the modular expanded foam pieces being inserted within the external protection container.

### DETAILED DESCRIPTION

Reference will now be made in detail to an embodiment of the present invention, an example of which is illustrated in the accompanying drawings.

### A. Definitions

Unless defined otherwise, all technical and scientific terms used herein have the same meaning as is commonly understood by one of skill in the art to which the inventions belong. All patents, patent applications, published applications and publications, websites and other published materials referred to throughout the entire disclosure herein, unless noted otherwise, are incorporated by reference in their entirety. In the event that there are a plurality of definitions for terms herein, those in this section prevail.

As used herein, the singular forms “a,” “an” and “the” include plural referents unless the context clearly dictates otherwise.

As used herein, ranges and amounts can be expressed as “about” a particular value or range. “About” also includes the exact amount. Hence, “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where the event or circumstance occurs and instances where it does not. For example, an optional component in a system means that the component may be present or may not be present in the system.

As used herein, a “combination” refers to any association between two items or among more than two items. The association can be spatial or refer to the use of the two or more items for a common purpose.

Throughout this disclosure, all parts and percentages are by weight (wt %) and all temperatures are in ° C., unless otherwise indicated.

As used herein, the phrase “based on the weight of the composition” with reference to % refers to wt % (mass % or (w/w) %).

As used herein, “packaging material” refers to materials for forming packages for protecting, carrying, or distributing products. Packaging material may include, for example, wraps, containers (e.g., for foods or beverages), boxes, cartons and canisters.

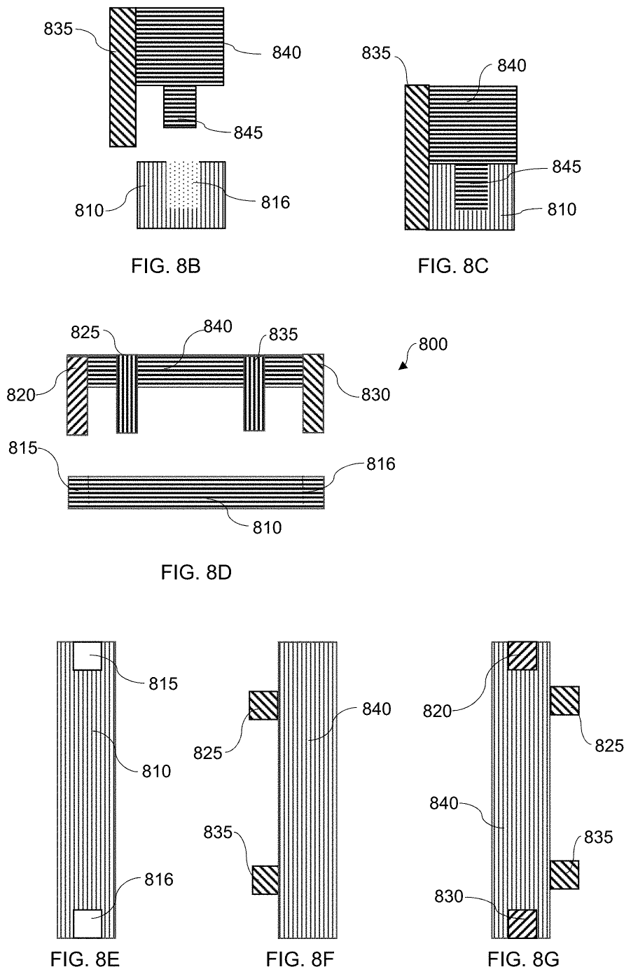

As used herein, “flute” refers to the arch-shaped structure of a corrugated sheet. Exemplary flutes are depicted in FIGS. 7A and 7B.

As used herein, “aqueous solution” refers to water in combination with one or more dissolved or dispersed materials. The aqueous solution does not require complete dissolution of the materials in the water. As used herein, “aqueous solution” includes suspensions and colloidal dispersions.

As used herein, a “dry coating weight” refers to a coating build-up on a substrate. The dry coating weight can be calculated by measuring a weight of the substrate prior to applying a coating, and a weight after that coating has been applied and dried, and subtracting the weight of the substrate before application of the coating from the weight of the substrate after the application and drying of the coating, and dividing the weight difference by a surface area of the substrate upon which the coating was applied.

As used herein, “additive” refers to a material or substance included in a layer or composite that provides a functional purpose. Examples of an additive include, but are not limited to, a filler, a fire retardant, an impact modifier, a plasticizer, a processing aid, and UV stabilizer, filler, mineral particle for hardness, and other forms of standard plastic or bioplastic additives.

As used herein, the term “biodegradable” typically means the ability for a material to be degraded or decomposed into smaller materials by microorganisms or other environmental factors. Typically, the material can be broken down into carbon dioxide and/or methane, water and other smaller molecular weight materials under aerobic and/or anaerobic conditions in the presence of fungi, bacteria, and other microorganisms. It is understood that biodegradable substances containing heteroatoms, such as N or S, can also produce products, such as ammonia or sulfur dioxide, respectively.

As used herein, the term “composting” refers to a human-controlled aerobic and/or anaerobic process in which a material is decomposed into carbon dioxide and/or methane, water and other smaller molecular weight materials. Composting is generally carried out under conditions ideal for biodegradation to occur, for example, reducing the particle size to increase surface area, controlling the temperature, humidity, and ventilation to control oxygen levels, and optionally inoculating with suitable microorganisms.

As used herein, the term “compostable” refers to the biodegradability of a material under certain composting conditions (e.g., controlled temperature, humidity, and oxygen level).

As used herein, “wheat straw paper” refers to a paper made from wheat straw and containing more than 50 wt % wheat straw fiber.

As used herein, “wheat flour” refers to flour produced from wheat, typically by milling after extraction of the bran. Wheat flour includes hard wheat flour (having a high protein content), weak wheat flour (having a lower protein content), and combinations thereof. The protein includes glutenin and gliadin. When the wheat flour is exposed to water and subjected to shear energy, such as kneading or mixing, glutenin and gliadin in the wheat flour combine and form gluten.

The term “gelatinized wheat flour” as used herein refers an aqueous solution that includes wheat flour heated to gelatinize the starch in the wheat flour. When the wheat flour is mixed with an aqueous solution or water and heated to a certain temperature, the starch granules in the wheat flour swell and release starch molecules to form a viscous, aqueous solution.

As used herein, “basis weight” refers to the grammage of a sheet of the paper substrate, with or without a coating layer, as determined by TAPPI test T410. See G. A. Smook, Handbook for Pulp and Paper Technologists (2nd Edition, 1992), pages 339-342, which describes the physical test for measuring basis weight.

Reference will now be made in detail to embodiments of the present invention, examples of which are illustrated in the accompanying drawings.

### B. Sustainable Biodegradable Protective Packaging System

The replacement packaging material provided herein utilizes agricultural waste to create an environmentally friendly biodegradable package. Corn and wheat are among the most grown and sometimes wasted agricultural products in the United States. Because there can be an excess of wheat or corn produced, the usage of these products in a replacement packaging system reduces the carbon footprints of the packaging and farming industries. In addition, wheat straw and corn stalks and husks have limited applications, such as for animal feed, and the excess is typically burned. This contributes to air pollution, impregnating the atmosphere with CO₂, thereby creating a general public health hazard. By avoiding the harvest of healthy trees for cardboard manufacture, and instead utilizing the otherwise burned or wasted agricultural products, trees could be spared from harvest to meet packaging demands and instead continue to function as efficient carbon sinks.

The replacement packaging material provided herein replaces conventional cardboard with a corrugated paperboard made from agricultural waste, such as wheat straw, to produce a container that is identical or substantially identical to that of current corrugated cardboard. Wheat straw paper also has a similar tensile strength to that of paperboard, the paper within the corrugated cardboard, and has a similar appearance as well. Cornstarch is used to produce a foamed insert that can replace traditional polystyrene foam. The process by which to create cornstarch foam is similar to the process by which polystyrene is foamed. This means that the integration of the solution into the current infrastructure established by the packaging industry will require minimal alterations.

Instead of using kraft paper derived from trees, the present invention uses an agricultural waste product, such as wheat straw, for forming paper, and cornstarch for forming an insert. These materials make the alternative biodegradable packaging system inexpensive and sustainable while maintaining the same amount of durability achieved using conventional materials. The wheat straw, turned into paperboard, requires the same process currently used by paper mills and plants to manufacture corrugated boxes. The inserts protect the contents of the packages. The creation of a cornstarch-based foam as an insert is inexpensive compared to polystyrene because corn is easy to produce and is a sustainable resource. Turning cornstarch directly into foam, or converting it into the polylactic acid (PLA) for foaming, uses relatively simple processes and technologies with few negative environmental side effects.

Ready adoption of the biodegradable protective packaging system provided herein by the electronic packaging and shipping industry is expected because of its similarities to the conventional corrugated cardboard box and polystyrene inserts, while reducing overhead costs associated with its adoption. Additionally, the cornstarch foam inserts cradling the electronic item within the exterior of the package can serve as a desiccant, impact absorber, and anti-static material, each feature instrumental in protecting consumer electronics during shipping and handling. The wheat straw paperboard can be produced with no unnecessary chemicals or bleaches, notably requiring no chlorine products during manufacture. Furthermore, the process of creating the cornstarch-based foam becomes carbon neutral when accounting for the carbon dioxide consumed by the maize plant during growth.

With the increasing pressure to be more environmentally friendly, companies in the e-commerce industry and packaging industry will be more inclined towards accepting a sustainable, durable packaging system such as provided herein. The combination of materials in the biodegradable protective packaging system provided herein solves the need for sustainable packaging due to the optimized durability for packages and adherence to a high standard of ecological friendliness. The present invention describes a durable package that simultaneously aids the environment and successfully protects its housed electronic components during shipping and handling.

The biodegradable protective packaging system provided herein serves as an alternative to the standard corrugated cardboard box and insert materials. By introducing a biodegradable, scalable, and financially feasible option to the market, the biodegradable protective packaging system provided herein introduces minimal invasive materials into the environment during manufacture and disposal. The biodegradable protective packaging system provided herein is biodegradable; the core ingredients of the packaging system decompose into basic components, blending into the soil and can be utilized by microorganisms, leaving no toxic material behind like plastic or plastic-derived products do. The bleaching process typically used during manufacturing can be eliminated in some embodiments, solely utilizing unbleached wheat pulp. The biodegradable protective packaging system provided herein offers a sustainable package that, when disintegrated, becomes a compost, integrating into the soil of the Earth's crust.

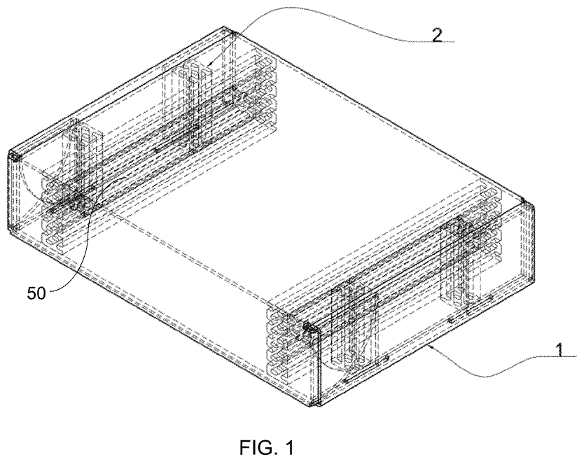

An exemplary embodiment is illustrated in FIG. 1. FIG. 1 illustrates an exemplary orientation of the packaging system provided herein, showing the corn foam insulation 2 integrated within the external protection container 1 made of a laminate in the form of a corrugated wheat fiber laminate. The corn foam insulation 2 is configured to include a cradle cavity 50 configured to receive a first end of an electronic device when the end of the electronic device is inserted into the cradle cavity 50.

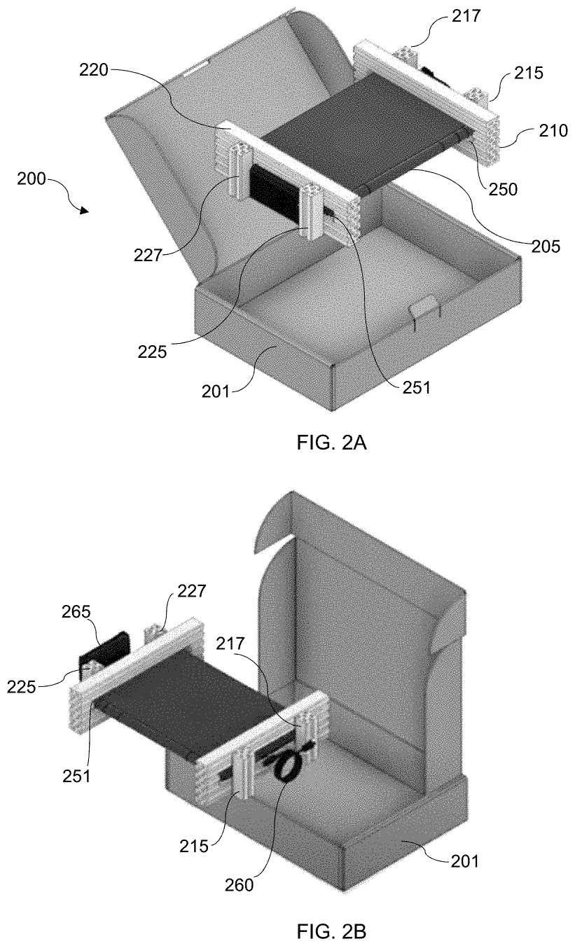

FIGS. 2A and 2B show illustrations of an exploded view of an exemplary packaging system from different viewing angles. FIG. 2A shows corn foam insulation inserts 210 and 220 at each end of an electronic device 205, with a cradle cavity in each of the corn foam insulation inserts (cradle cavity 250 in foam insulation insert 210 and cradle cavity 251 in foam insulation insert 220) that accepts as least a portion of the end of the electronic device 205 to cradle the electronic device 205 so that the electronic device 205 is not in contact with a surface of external protection container 201. Corn foam insulation insert 210 includes a first columnar support 215 and a second columnar support 217. Corn foam insulation insert 220 includes a first columnar support 225 and a second columnar support 227.

When the corn foam insulation inserts 210 and 220 cradling the electronic device 205 are inserted in the external protection container 1, air spaces are formed around the electronic device so that it is separate and apart from the external protection container and is not in contact with any surface of the external protection container. Because the cradle cavity is located within each of the corn foam insulation inserts 210 and 220, air spaces are formed above and below the electronic device 205 and the top and bottom of external protection container 1, providing protection from shock and stress that typically accompanies shipping and handling.

FIG. 2B shows corn foam insulation inserts 210 and 220 at each end of an electronic device 205, and illustrates an embodiment where a power cord 260 can be placed within the space created by the first columnar support 215 and the second columnar support 217 of the corn foam insulation insert 210, and a power adapter 265 can be placed within the space created by the first columnar support 225 and the second columnar support 227 of the corn foam insulation insert 220.

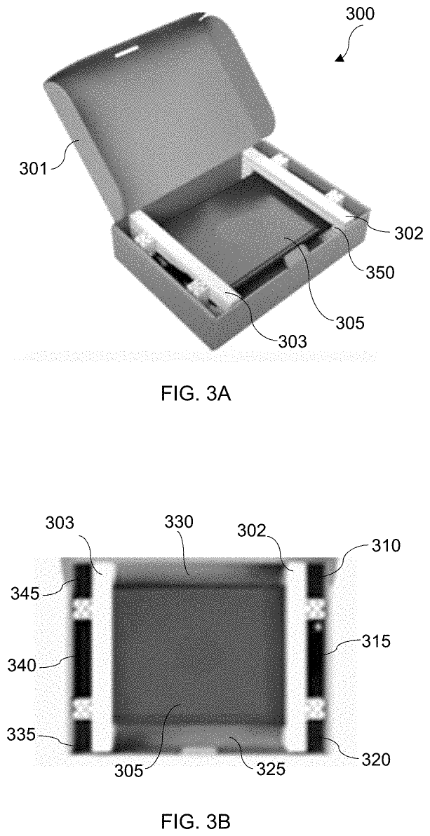

FIG. 3A shows an illustration of a perspective view of an exemplary embodiment of the packaging system 300 with the lid of the external protection container 301 open to show the inside of the external protection container 301 containing the corn foam insulation inserts 302 and 303, each of which is positioned at an end of the electronic device 305 cradling the electronic device 305 by accommodating at least a portion of each end of the electronic device in a cradle cavity 350.

FIG. 3B shows an illustration of a top view of the inside of the external protection container 301 containing the corn foam insulation inserts 302 and 303 at each end of the electronic device 305. FIG. 3B shows the air spaces that surround the electronic device so that the electronic device does not come into contact with any surface of the external protection container. The corner air spaces 310, 320, 330, and 340 provide cushioning and protection should the package be dropped and hit a corner. The impact from falling can be absorbed by the external protection container 300, which can withstand the stress and pressure if the fall is from a short distance, or can deform, crumple or crush to dissipate the energy from a fall from a long distance, transferring little or no impact stress to the electronic device 305. Side air spaces 315 and 325 provide similar protection should a dropped package land on the short edge of the packaging. The laminate of the external protection container 701 can help to distribute any stress or impact energy over a larger area, while the corn insulation minimizes transfer of the stress or impact energy to the electronic device 305. The front void area 335 and rear void area 345 provides similar protection to the electronic device should the package be dropped. Although not depicted in FIG. 3B, air spaces are formed above and below the electronic device 305, creating space between the electronic device 305 and the top and bottom of external protection container 1. These air space areas also provide protection from shock and stress that typically accompanies shipping and handling, as well as any dropping or mishandling of the package during shipment.

1. Wheat Straw Paper Composite

The biodegradable protective packaging systems provided herein include as an element an external protection container made of a biodegradable non-wood based paper composite. Although described herein as made of wheat straw fiber, any agricultural product fiber, such as, but not limited to, corn stalk, corn husks, or sugar cane fiber, could be used, alone or in combination with the wheat straw fiber.

a. Wheat Straw Fiber Paper

In one embodiment, wheat straw fiber is used to form a composite that is used to form the external protection container. The composite comprises wheat straw fiber paper and a wheat flour film.

The wheat straw fibers used in the composite originate from wheat straw. The wheat straw fibers typically have less lignin and more hemicellulose, and are characteristically shorter and narrower than those of wood. Methods for processing the collected wheat straw and processes used for production of wheat straw paper are known in the art (e.g., see Leponoemi, “Fibers and energy from wheat straw by simple practice,” Doctoral Dissertation, VTT Publications 767, VTT Technical Research Centre of Finland, ISBN 978-951-38-7743-9, (2011), the entire contents of which specifically is incorporated in its entirety). The processes can include any one or more of a chemical treatment of the straw with formic acid for preservation prior to processing to recover the fiber, hot water treatment, mild alkali treatment, alkaline peroxide bleaching, peracid treatment, and mechanical defibrillation. In some embodiments, the cleaned wheat straw undergoes a pulping process that includes treatment with alkaline anthraquinone solution that dissolves and removes lignin from the wheat straw, resulting in formation of what is known in the art as black liquor. The delignified wheat straw then goes through a pulp washer using techniques to remove the black liquor.

An optional bleaching step can be performed after removal of the black liquor. Although the bleaching may resulting in a pulp having a more pleasing aesthetic appears because it results in a whiter brighter pulp, bleach treatment can diminish the biodegradable nature of the finished wheat straw paper and can cause any residual lignin or pentosans in the pulp to degrade. This degradation can cause the paper to absorb large amounts of water during paper manufacture, having a significant negative impact on water drainability and processability during paper web formation. The degraded lignan and carbohydrates that can be produced during the bleaching process also can react to form a paper that appears dull and weak (Gere, “Advantages and Disadvantages of Cardboard Boxes [Infographic], (2021), available from: https://confessionsoftheprofessions.com/advantages-disadvantages-cardboard-boxes-infographic.). Accordingly, in some embodiments, an unbleached wheat straw fiber pulp is preferred for paper formation.

The wheat straw fiber pulp can be subjected to a refining process. The wheat straw fiber pulp can be subjected to mechanical refining to produce a refined fiber. The refining process increases the total surface of the fibers available for bonding. For example, the wheat straw fiber pulp can be added to a hydro-pulper with warm to hot water (10-100° C., such as 50-90° C.) to result in a percentage of pulp in the water of about 1 wt % to about 25 wt %, such as from about 1 wt % to about 10 wt %. The mixture is mixed for a period of time from about 10 minutes to 60 minutes to form a slurry of dispersed fiber.

The dispersed fiber then is subjected to mechanical refining. The slurry optionally can be diluted to a concentration of about 0.1 wt % to about 5 wt % fiber in the slurry prior to refining. Refining can be achieved using any fibrillating equipment known in the art. Exemplary equipment for refining the fiber includes a Hollander beater, a Conflo refiner, a conical refiner, a disc refiner, a double disc refiner, a British disintegrator, an angle disintegrator, a blender, a homogenizer, a microfluidizer, or any combination thereof. These can be used singly or in any combination. When a blender is included, the blender can be fitted with one or more blades, and the blades can be X style, wing style, or combinations thereof. Exemplary blenders and blades are described, e.g., in U.S. Pat. No. 6,632,013 (Douglas et al., 2003); U.S. Pat. No. 6,974,099 (Kolar et al., 2005); U.S. Pat. No. 6,981,795 (Nikkah, 2006); U.S. Pat. No. 8,197,121 (Sands, 2012); and U.S. Pat. No. 8,444,076 (Rukavina, 2013).

In some applications, the mechanical refiner can include a disk or conical refiner with plates designed for low intensity or medium intensity refining. In some applications, the mechanical refiner can include a double disc refiner. The refining can include a thermo-mechanical refining process that includes refining under high temperature and elevated pressure, such as a pressure of from about 2 bars to about 16 bars, and a temperature greater than about 150° C. up to about 185° C.

After refining, one or more fillers optionally can be added to the slurry to produce a furnish. The slurry then can be deposited on the wire of the papermaking device or apparatus, followed by removal of water from the furnish to produce a raw paper material. An additive or coating or both optionally can be applied to a surface of the raw paper material. The raw paper material or treated raw paper material then is subjected to a pressing step that applies pressure to the raw paper material to remove water, followed by a drying step to apply thermal energy to remove water to a target moisture level in the paper.

The wheat straw paper contains at least 50 wt % virgin wheat straw fiber. The wheat straw paper can contain 50 wt %, 55 wt %, 60 wt %, 65 wt %, 70 wt %, 75 wt %, 80 wt %, 85 wt %, 90 wt %, 95 wt %, 96 wt %, 97 wt %, 98 wt %, 99 wt % or 100 wt % virgin wheat straw fiber based on the total weight of the paper.

The wheat straw paper can include up to 45 wt % of a non-wood agricultural fiber other than virgin wheat straw fiber. In some embodiments, the wheat straw paper can include 5 wt %, 10 wt %, 15 wt %, 20 wt %, 25 wt %, 30 wt %, 35 wt %, 40 wt % or 45 wt % of recycled wheat straw fiber.

The wheat straw paper can include up to 45 wt % of a non-wood agricultural fiber other than virgin wheat straw fiber or recycled wheat straw fiber. Examples of such non-wood agricultural fibers include, but are not limited to, abaca, bamboo, corn husk fiber, corn stalk fiber, cotton, flax, hemp, jute, kenaf, rice straw fiber, recycled wheat straw fiber, sisal fiber, sugarcane bagasse fiber, and combinations thereof. The wheat straw paper can include 5 wt %, 10 wt %, 15 wt %, 20 wt %, 25 wt %, 30 wt %, 35 wt %, 40 wt % or 45 wt % of any one or a combination of these non-wood agricultural fibers.

The wheat straw paper can include a filler selected from among a starch, a dextrin, a maltodextrin, gum arabic, calcium carbonate, magnesium carbonate, clay, calcined clay, kaolin, titanium oxide, an alkaline earth phosphate, and a combination thereof. When present, the filler can be present in an amount of from about 0.5 wt % to about 20 wt % based on the overall weight of the wheat straw paper. The non-mineral additives can not only contribute to the functional properties of the paper, but can help in biodegradability of the paper, as the microbes usually present in composts and landfills can utilize the carbohydrates (starch, dextrin, maltodextrin, and gum arabic) and phosphates to promote growth.

The resulting wheat fiber paper can have a basis weight or grammage of from about 75 g/m² to 450 g/m². For example, when the targeted paper is a linerboard for a corrugated container, the paper typically can have a basis weight or grammage of 100 g/m² to 250 g/m². For a corrugated medium, the paper typically can have a basis weight or grammage of 100 g/m² to 200 g/m². Because the packaging system provided herein utilized a composite of wheat straw paper and wheat flour film, paper of lower basis weight than typically used with wood-based paper can be used and achieve the same or similar properties of higher basis weight wood-fiber passed paper.

The chemical and physical properties of wheat straw paper have been reported in the art (e.g. see Au et al., “An investigation into the Wheat Straw Paper,” University of British Columbia. APSC 262; UBC Social Ecological Economic Development Studies (SEEDS) Student Report, DOI 10.14288/1.0108551 (2014)), the entire contents of which is specifically incorporated in its entirety.

Wheat straw paper is available from Prairie Paper Inc (La Salle, Manitoba, Canada), as well as companies in India (Trident Group, Punjab, India) and China (e.g., Shandong Tranlin Paper (Shandong Tranlin Paper, Gaotang County, Liaocheng, Shandong, China; and Yinge Paper, Yancheng Qu, Luohe Shi, Henan Sheng, China)).

b. Wheat Flour Film

The wheat straw composite provided herein also includes a wheat flour film. The flour from soft wheat, hard wheat, or combinations thereof can be used to form the wheat flour film. Soft wheats typically contain from about 8 to 12 wt % protein. Hard wheats typically contain from about 12 to 15 wt % protein. The type of wheat used to produce the flour is not restricted as long as there is a minimum of 8 wt % in the flour. Glutenin and gliadin, which can be found in somewhat equal proportions in some wheat flours, generally account for about 80% of the total proteins in wheat flour. In most wheat flours, gliadins typically make up about 30%, and glutenin typically make up about 50% of the total protein in wheat flour, depending on cultivar and growing region.

The inventors have found that when a wheat flour film is made having at least 8 wt % total protein in the flour, the resulting starch flour film exhibits good adhesiveness and tensile strength. When applied to a surface of wheat fiber paper, the wheat flour film can improve the tensile strength and Scott Bond bonding test results of the resulting wheat straw paper composite when compared to the results achieved by wheat straw paper alone.

A wheat flour or a blend of different wheat flours can be selected so that the amount of total protein in the wheat flour is from about 8 to 15 wt % protein. The wheat flour can contain at least 8 wt %, 9 wt %, 10 wt %, 11 wt %, 12 wt %, 13 wt %, or 14 wt % protein. The wheat flour can contain from about 9 wt % to about 15 wt % protein, or from about 10 wt % to about 14 wt % protein, or from about 11 wt % to about 13 wt % protein, or from about 12 wt % to about 14 wt % protein, or from about 12 wt % to about 15 wt % protein.

A wheat flour or a blend of different wheat flours can be selected so that the amount of gliadins in the wheat flour is from about 1 to 4 wt % gliadins. The wheat flour can contain at least 1 wt %, 1.5 wt %, 2 wt %, 2.5 wt %, 3 wt %, or 3.5 wt % gliadins. The wheat flour can contain from about 1 wt % to about 4 wt % gliadins, or from about 2 wt % to about 3.5 wt % gliadins, or from about 3 wt % to about 4 wt % gliadins, or from about 3 wt % to about 3.5 wt % gliadins.

A wheat flour or a blend of different wheat flours can be selected so that the amount of glutenins in the wheat flour is from about 4 to 6 wt % glutenins. The wheat flour can contain at least 4 wt %, 4.5 wt %, 5 wt %, or 5.5 wt % glutenins. The wheat flour can contain from about 4 wt % to about 6 wt % glutenins, or from about 4.5 wt % to about 5.5 wt % glutenins, or from about 5 wt % to about 6 wt % glutenins, or from about 4 wt % to about 5.5 wt % glutenins.

A wheat flour or a blend of different wheat flours can be selected so that the amount of gluten formed in the wheat flour when moistened or exposed to an aqueous solution is from about 8 to 13 wt % gluten. The wheat flour can result in formation of at least 8 wt %, 9 wt %, 10 wt %, 11 wt %, 12 wt %, or 13 wt % gluten when moistened or exposed to an aqueous solution. The wheat flour can yield from about 8 wt % to about 13 wt % gluten, or from about 9 wt % to about 12 wt % gluten, or from about 10 wt % to about 11 wt % gluten, or from about 10 wt % to about 13 wt % gluten.

The wheat flour film can be formed by preparing a wheat flour slurry and applying it to at least one surface of the wheat straw paper. Typically, an aqueous dispersion of the wheat flour is prepared and then heated to gelatinize the starch and activate the protein components. The amount of wheat flour present in the aqueous dispersion can be from about 5 wt % to about 15 wt % based on the total weight of the dispersion. In some embodiments, the amount of wheat flour is 5 wt % to 15 wt %, or 5 wt % to 10 wt %, or 10 wt % to 15 wt %, or 6 wt % to 9 wt %, or 6 wt % 14 wt %, or 7 wt %-13 wt %, or 8 wt % to 12 wt %, or 9 wt %-10 wt %, based on the total weight of the dispersion. The dispersion can be made using distilled water, deionized water, a synthetic soft or hard water (Smith et al, “Methods of preparing synthetic freshwaters,” Water Research 36: 1286-1296 (2002)), or a buffer solution, such as a phosphate, TRIS, citrate, or acetate buffer.

Once the wheat flour is dispersed in the aqueous medium to form a homogeneous dispersion, heat was applied with constant mixing until the mixture boiled (typically at or about 100° C. for the distilled and deionized water, and close to about 100° C. for the synthetic waters or buffers, depending on the dissolved salts in the aqueous solutions). Boiling can be maintained for a time period from 1 to 5 minutes resulting in the formation of a viscous liquid. This viscous liquid when applied to a surface of a wheat fiber paper and allowed to dry results in the formation of the wheat flour film.

c. Composite Formation

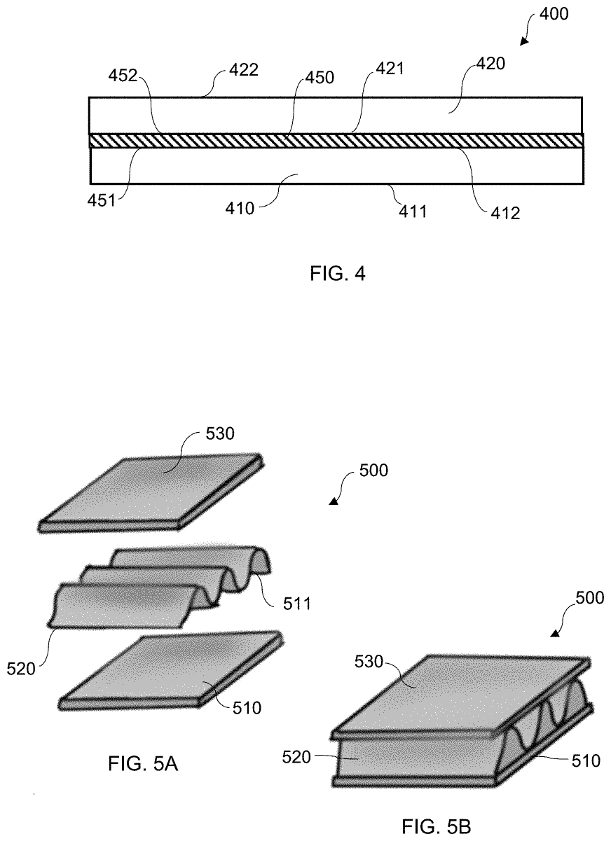

Provided herein is a wheat straw paper composite for a packaging material that includes a first wheat straw paper, a wheat flour film, and a second wheat straw paper. An exemplary embodiment is shown in FIG. 4. As shown in FIG. 4, the wheat straw paper composite 400 includes a first layer of wheat straw paper 410 that has a first surface 411 and an opposite second surface 412. The composite 400 also includes a second layer of wheat straw paper 420 that has a first surface 421 and an opposite second surface 422. The composite 400 also includes a wheat flour film 450 that has a first surface 451 and an opposite second surface 452. The composite 400 is configured so that the first wheat straw paper 410 includes on its surface 411 a layer of wheat flour film 450. The first surface 451 of the wheat flour film is in contact with the surface 412 of the first layer wheat straw paper. The surface 421 of the second layer of wheat straw paper 420 is in contact with the second surface 452 of the wheat flour film 450.

A method for forming wheat straw paper composite is provided. The method includes providing a first wheat straw paper layer, applying a cooked wheat flour composition to a layer of the first wheat straw paper to form a wet layer, applying a second wheat straw paper layer on the wet layer, and drying to remove moisture to form a wheat flour film between the first and second wheat flour papers to yield the wheat straw paper composite. The cooked wheat flour composition can at least partially migrate into and at least partially saturate each surface of the wheat straw papers in contact with the cooked wheat flour composition prior to drying. This results in good adhesion between the wheat straw paper layers and the wheat flour film. An optional step of applying pressure during drying can be performed.

The cooked wheat flour composition can be applied by a known method such as casting, direct gravure coating, reverse gravure coating, offset gravure coating, smooth roll coating, brush roll coating, spread coating, blade coating, spray coating, kiss coating, die coating, dipping, spraying, applicator roll coating, jet applicator coating, curtain coating, or bar coating.

The dry coating weight for targeted levels of pickup of the cooked wheat flour composition applied to the wheat straw paper can be in the range of about 0.5 g/m² to about 25 g/m², or in the range of 0.75 g/m² to about 15 g/m², or in the range of about 1 g/m² to about 10 g/m², or in the range of about 1 g/m² to about 5 g/m², or in the range of about 1.5 g/m² to about 15 g/m². The applied solids of the cooked wheat flour composition can be in a range of about 5 wt % to 15 wt %.

Two or more coatings can be applied. For example, a first coating of the cooked wheat flour composition can applied to the wheat straw paper and dried to form a wheat flour film, and then a second coating of the cooked wheat flour composition can applied to the surface of the dried wheat flour film, and a piece of wheat straw paper applied to the wet second coating, followed by drying.

Alternatively, a coating of the cooked wheat flour composition can applied to a first wheat straw paper, and a coating of the cooked wheat flour composition can applied to a second wheat straw paper, and the coated wheat straw papers can be brought into contact with each other so that the layers of coating of the cooked wheat flour composition are in contact with other, and the combination then dried to form a wheat four film between the two sheets of wheat straw paper.

Partial drying of one or both of the coated wheat straw papers can be performed prior to bringing the two coated wheat straw papers into contact with each other. For example, a coating of the cooked wheat flour composition can be applied to a first wheat straw paper, and the coated first wheat straw paper subjected to drying to reduce the water content of the cooked wheat flour composition on the surface of the wheat straw paper to be 20 wt % to 80 wt % of the water content of the cooked wheat flour composition prior to application to the surface of the wheat straw paper. A coating of the cooked wheat flour composition can be applied to a second wheat straw paper, and the partially dried coated first wheat straw paper can be brought into contact with the coated second wheat straw paper so that the layers of cooked wheat flour composition are in contact with each other. In an additional embodiment, a coating of the cooked wheat flour composition can applied to a first wheat straw paper and to a second wheat straw paper, and the coated first wheat straw paper and coated second wheat straw paper subjected to drying to independently reduce the water content of the cooked wheat flour composition on the surface of each of the wheat straw papers to be 20 wt % to 80 wt % of the water content of the cooked wheat flour composition prior to application and drying. The partially dried coated first wheat straw paper and partially dried coated second wheat straw paper then can be brought into contact with each other so that the layer of cooked wheat flour composition on each wheat straw paper are in contact with each other.

Drying can be accomplished by air drying, or placing in or passing through a drying oven, or via hot air flow, or via heating in an infrared unit or passing through an infrared heating unit, or via use of an airborne dryer, or via combinations of these drying techniques.

The wheat straw paper composite can subjected to a pressure treatment. For example, a hot platen press with pressure ranging from about 5 psi to over 500 psi can be used, depending on the final desired specific gravity or hardness of the composite. In another embodiment, a hot roll press can be used to apply heat and pressure to further fuse together the layers of the composite.

2. Agricultural Waste Paperboard Production

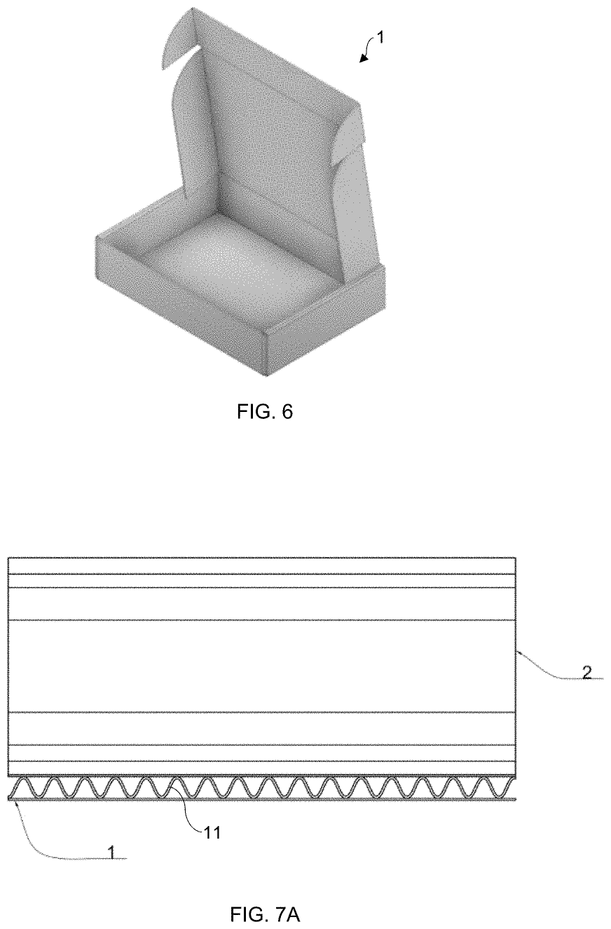

The wheat straw paper composite can be used to form a laminate. An exemplary laminate is shown in FIGS. 5A and 5B. FIG. 5A shows an exploded view of a laminate 500 of three components: a first wheat straw paper composite 510 and a second wheat straw paper composite 530 provided as flat sheets, and in between these flat sheets 510 and 530 is a corrugated wheat straw paper composite 520. The corrugated wheat straw paper composite 520 has a plurality of flutes 511. FIG. 5B shows an exemplary laminate in which the corrugated wheat straw paper composite 520 is adhered to a surface of the first wheat straw paper composite 510 and to a surface of the second wheat straw paper composite 530. The surfaces can be adhered to each other using any biodegradable adhesive known in the art. The wheat straw paper composites can be prepared as set forth above.

Corrugation can be achieved using technology known in the art. For example, systems that utilize a pair of corrugated rollers can be used in order to create the corrugation. Typically, the piece of paper, or in this case the wheat straw paper composite, is heated, making it more malleable. The heated composite then is fed between rollers where increased pressure, such as around one hundred eighty pounds of pressure per square inch, is applied by both rollers, with elevated temperatures, such as at high as 185° C. (U.S. Pat. No. 8,753,844 (Elisashvili, 2014)). Because of the temperature and pressure, the heated composite is able to bend around the flutes on the rollers, forming the corrugated sheet, typically having the familiar shape of the middle portion of cardboard. When creating corrugated paper, the specialization grade of the paper determines its functionality and usage. The combination of different grades of Kraft paper dictates the mechanical attributes of the desired product (Fang, “Wheat Straw Pulping for Paper and Paperboard Production,” Chapter 12 in “Global Wheat Production,” pages 223-239 (2018)). Similarly, different formulations of wheat straw fiber paper having similar properties to wood-based Kraft paper can be used when preparing the wheat straw paper composite.

A corrugator machine can be used to unwind three continuous sheets of wheat fiber paper composite provided herein from rolls, pressing flutes into a sheet to firm a corrugating medium which is the central portion of the laminate provided herein, and applying an adhesive to the tips of the flutes to affixes the external sheets of wheat fiber paper composite to form corrugated laminate.

Although FIG. 5 depicts a corrugated laminate in the form of a single wall board, the wheat straw paper composite can be used to make double wall board and triple wall board. In the corrugated sheet, the number of flutes 511 can be anywhere from 30 to 130, and the height of each flute can be anywhere from 1.5 mm to 5 mm. For shipping containers, the number of flutes typically is from about 35 to 50, having flute heights of about 3.0 mm to 6.5 mm. The fluting can allow transfer of applied pressure and the voids between the flutes provides cushioning to increase the protecting properties of the corrugated laminate when used as a shipping container. Containers containing conventional A, B, C, E or F flute sizes can be made, or combinations of such flutes, such as A/B flutes, A/C flutes, B/C flutes, B/C/E flutes, E/B flutes, E/C flutes E/C/E flutes, E/E flutes, and F/E flutes. Different flute size can be combined to modify the cushioning strength and/or compression strength of the final container.

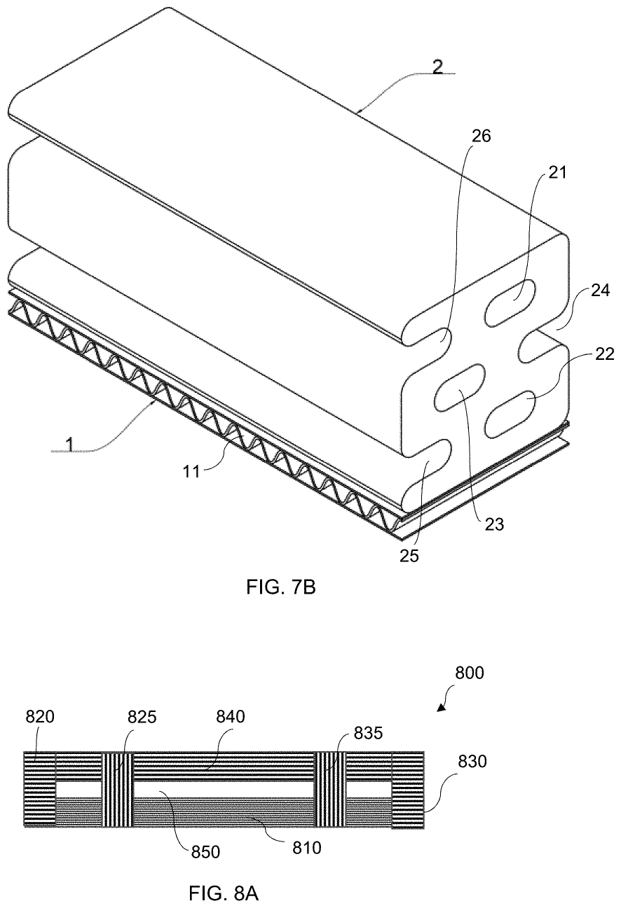

In one embodiment, wheat straw paper composite can be used to form an external protection container, typically having the characteristics of conventional corrugated fiberboard boxes. An exemplary external protection container is shown in FIG. 6. Although FIG. 6 depicts the external protection container 1 in the form of a tray form container, the corrugated laminate provided herein, made from wheat straw paper and a wheat flour film, can be in the shape of any conventional container, including bliss or rigid boxes, folders, interior forms, self-erecting boxes, slotted boxes, and telescope boxes.

3. Corn-Based Foamed Insulation Inserts

In terms of providing internal protection for an electronic device to be shipped, corn-based products, particularly foam insulation products that utilize a material from corn, can be used. In some embodiments, an extruded cornstarch foam insulation is used. In some embodiments, a foamed polylactic acid product (derived from cornstarch) is used. The corn foam insulation can be in contact with the external protection container. Corn-based products were selected as the base for the insulation material because corn is a reliable crop and often overproduced by agriculturists resulting in excess corn products.

An exemplary embodiment is shown in FIGS. 7A and 7B. FIG. 7A is a partial cross-sectional side profile view of an example of the packaging system that includes an external protection container made of a laminate in the form of a corrugated wheat fiber cardboard 1 as a base, and in contact with at least a portion of the external protection container 1 is a corn foam insulation insert 2. FIG. 7B shows a partial cross-sectional perspective view of an example of the packaging system that includes an external protection container 1 made of a laminate in the form of a corrugated wheat fiber laminate containing a plurality of flutes 11 as a base, and in contact with at least a portion of the external protection container 1 is a corn foam insulation insert 2, which includes voids 21, 22, and 23, and spaces 24, 25, and 26 in the corn foam insulation. The voids 21, 22, and 23 allow the corn foam insulation insert 2 to be resilient and at least partially compress when a force is applied perpendicularly, and can decompress and return to the original or substantially original position when the applied force is removed. The spaces 24, 25, and 26 are a result of the folds designed into the extruded corn foam insulation 2, and allows the extruded corn foam insulation 2 to move to help dissipate any non-uniformly applied force or energy.

Cornstarch Foam Insulation

Foam insulation from cornstarch and methods for its production are known in the art (e.g., see U.S. Pat. App. Pub. Nos. 2020/0017258 (Branham); 2018/0229917 (Jobe); and 2012/0097067 (Fascio); and U.S. Pat. No. 3,137,592 (Protzman et al., 1961); U.S. Pat. No. 3,891,624 (Boonstra et al., 1975); U.S. Pat. No. 4,863,655 (Lacourse et al., 1989); U.S. Pat. No. 4,900,361 (Sachetto et al., 1990); and U.S. Pat. No. 5,252,271 (Jeffs, 1993). The foam serves as a desiccant, impact absorber, and anti-static which protects the product from shock and vibration, electrostatic discharge, and humidity, which are the most important considerations in packaging electronics (Lomont Molding LLC, 2021).

The conventional process for forming a foamed product from cornstarch uses an extruder or an injection molding machine or a combination thereof. For example, the starch and any additive feed material can be fed through a hopper onto a rotating, reciprocating screw. Exemplary additives that could be used include glycerol as a plasticizer, dibasic acid, acid anhydride, poly(hydroxyl amino ether), poly(hydroxyl ether), poly(caprolactone), cellulose acetate, and combinations thereof.

The cornstarch used for preparing the cornstarch foam can be selected to have the desired properties. Exemplary cornstarch that can be used include native cornstarch, high amylose cornstarch, high amylopectin cornstarch, modified cornstarch, and combinations thereof. The modified starches can include acid treated starch, enzymatically modified starch, alkali treated starch, dextrinized starch, hydroxymethylated starch, hydroxyethylated starch, hydroxypropylated starch, octenyl succinic anhydride modified starch, starch acetates, starch phosphates, oxidized starch, acetylated oxidized starch, and combinations thereof. For example, a hydroxypropylated high amylose (45% or higher amylose) starch can be used. A hydroxypropylated high amylose having 70% or higher amylose starch can be used.

The cornstarch-based foam typically includes about 60 wt % or more cornstarch. The cornstarch-based foam can include from about 60 wt % to about 98 wt % cornstarch. The cornstarch-based foam can include from about 70 wt % to about 95 wt % cornstarch. The cornstarch-based foam can include from about 80 wt % to about 93 wt % cornstarch. The cornstarch-based foam can include from about 85 wt % to about 95 wt % cornstarch.

The feed material moves along a screw inside a barrel towards an exit tip. During this process, the temperature of the feed material in the barrel is increased by means of frictional forces caused by the shearing action of the screw, and supplemental heating can be provided by external heaters around the outside of the barrel. The particulate feed becomes gradually molten as it is conveyed through the barrel, typically through different zones, such as compression zones and metering zones, where homogenization of the melt occurs. At the end of the screw and barrel, the molten material exits via a tip. The molten material can then be further treated by injection molding or extrusion or any other known technique to treat thermoplastic melts.

While the material is under pressure within the barrel of the extruder, it is heated above atmospheric boiling temperature, remaining in the liquid state due to the pressure within the barrel. As the material comes out of the tip, it re-equilibrates with atmospheric pressure, causing water in the suspension to vaporize. This creates both a foaming and drying action, and if constrained within a mold, the extruded material expands to take the shape of the mold.

The molten cornstarch material can instead be extruded to form a length or rope of exudate having a desired cross-section. The achieve this, the molten material can be pushed through a die of the desired cross-section. The extruded material can have any one of various shapes, such as S-shaped, O-shaped, H-shaped, Y-shaped, U-shaped, spiral-S-shaped, triangle-shaped, square-shaped, hexagon-shaped, truncation pyramidal-shaped, and trapezoidal-shaped (e.g., see U.S. Pat. App. Pub. No. 2012/0097067 (Fascio) which illustrates several different extruded shapes). A complex shape in the form similar to the shape of “3B” as shown as item 2 in FIG. 4B also can be formed by appropriate design of the die cross-section. In some of the extrusions, like the O-shape, the 8-shape, the triangle shape, the star shape, and the “3B” shape, there is/are one or more internal void spaces running the length of the extrusion, formed by an interior wall of the same material as the outer shell. For example, in FIG. 4B, the “3B” shaped corn insulation material includes internal voids 21, 22, and 23. The extruded shapes can be combined with each other or with a flat extruded sheet to form composite shapes, or to achieve a desired thickness of the cornstarch foam, or both. For example, the open end of multiple U-shaped extruded foam pieces can be adhered to a flat sheet of extruded foam to form a foam composite with a corrugated appearance. Several “3B” shaped extruded foams also can be adhered together to form a foam composite sheet. Two or more of these foam composite sheets then can be adhered to each other to achieve the desired thickness of the final composite foam sheet.

The cornstarch foam is biodegradable and readily degrades when exposed to the natural outdoor environment, particularly when exposed to water. In some instances, the cornstarch foam insulation can be formulated so that it readily dissolves in hot water, allowing the extruded cornstarch foam insulation to be melted in a sink and readily disposed without being deposited in a landfill. The cornstarch foam can include a green dye to indicate that the cornstarch foam is biodegradable. The cornstarch foam can include a blue dye to indicate that the cornstarch foam is water soluble.

To avoid sanding or dust creation due to frictional forces between the external protection container and the cornstarch foam insulation, the cornstarch foam insulation can be coated with a biodegradable coating. It has been found that a coating of a water-soluble polyvinyl alcohol, a readily biodegradable polymer, provided the desired friction reduction properties to reduce sanding and dust creation, while having minimal to no impact on dissolution of the foam when exposed to water or biodegradability. The polyvinyl alcohol coating completely dissolves when exposed to water, and thus the resulting foam can be disposed of by exposing to water, particularly hot water, in a sink and subsequent treatment in a sewer treatment plant or a septic system. Polyvinyl alcohol also can be consumed by many environmental microbes, including fungi and bacteria, allowing biodegradation if composted or landfilled.

While the external protection container that includes a laminate of at least three wheat straw paper composites to from a corrugated wheat-fiber paperboard is resistant to physical damage and stresses associated with shipping by itself, the cornstarch foam insulation provides a sustainable biodegradable material for internal protection for the electronic device, such as a computer, to be shipped. To avoid the use of polystyrene products, which are made of synthetic resin and do not biodegrade, the biodegradable cornstarch foam product described herein is used as an alternative. Studies have shown that some configurations of cornstarch-based foam products can be as protective as polystyrene (Montgomery, “Could These Materials be the Future of Packaging?”, Lumi Blog (2019)). The cornstarch-based foam insulation can serve as a desiccant, impact absorber, and anti-static material, which protects the electronic device from shock and vibration, electrostatic discharge, and increasing humidity.

An exemplary cornstarch foam that can be used is GREEN CELL FOAM™ cornstarch-based foam available from KTM Industries (Lansing, Mich.). GREEN CELL FOAM™ cornstarch-based foam typically includes 90 wt % or more cornstarch. The foam also includes from 1 wt % to 10 wt % water and/or processing aids and/or proprietary additives. GREEN CELL FOAM™ cornstarch-based foam is a medium density, closed cell foam (see U.S. Pat. No. 8,029,636 (Wycech, 2011)). The GREEN CELL FOAM™ cornstarch-based foam is flexible and can but cut to the desired shape using conventional cutting devices, such as scissors or saws. Two or more sheets of GREEN CELL FOAM™ cornstarch-based foam can be adhered to each other to achieve the desired thickness. Any biodegradable adhesive can be used to adhere the sheets together, such as those described in U.S. Pat. No. 6,444,761 (Wang et al., 2002), or commercially available biodegradable adhesives (such as Nyatex Laminating Adhesive No. 20L0892HSR from Nyatex Adhesive and Chemical Company (Howell, Mich.), AQUABOND® water soluble biodegradable adhesives from Aquabond Technologies (Camarillo, Calif.)).

Cornstarch-based foam insulation sheets can be cut to the desired size to accommodate an electronic device to be protected within the external packaging container. Multiple cornstarch-based foam insulation extruded material, regardless of shape, can be adhered together using a biodegradable adhesive to achieve the desired thickness of cornstarch-based foam insulation to be used as or to construct a packaging insert.

The cornstarch-based foam, once submerged in or continuously sprayed with water can disintegrate in minutes, making it a viable fertilizer for plants; made of cornstarch and injected with nitrogen as an expanding agent or expanded with steam when exiting an extruder, there are no pollutants in its base ingredients. With fertilizers already containing nitrogen, with some also containing phosphorus and potassium, and cornstarch containing 3 mg of potassium per 100 g, the cornstarch-based foam, such as GREEN CELL FOAM™ cornstarch-based foam can serve as a viable alternative to fertilizers (“Fertilizer,” MadeHow (2021), available from www.madehow.com/Volume-3/Fertilizer.html#ixzz734ONnfvF). Plants rely on nitrogen to synthesize proteins, nucleic acids, and hormones, with nitrogen deficient plants demonstrating a yellowing of the leaves or reduced growth. Nitrogen-containing or phosphorous-containing compounds can be included as additive during cornstarch-based foam formation, increasing the amount of these nutrients available to plants when the cornstarch-based foam decomposes, releasing the compounds into the environment.

The packaging system provided herein is a sustainable, biodegradable, anti-static, and desiccant product that optimizes the usage of biodegradable materials while simultaneously protecting the integrity of the electron device, such as a computer, packaged within the packaging system. The packaging system provided herein can be manufactured using current conventional fabrication techniques and equipment that resemble conventional commercial operations.

The cornstarch-based foam can be provided as an insert for receiving and protecting an electronic device. The insert can be configured to be two separate parts that combine and nest together to form a cradle cavity that can accept and support at least a portion of one end of the electronic device.

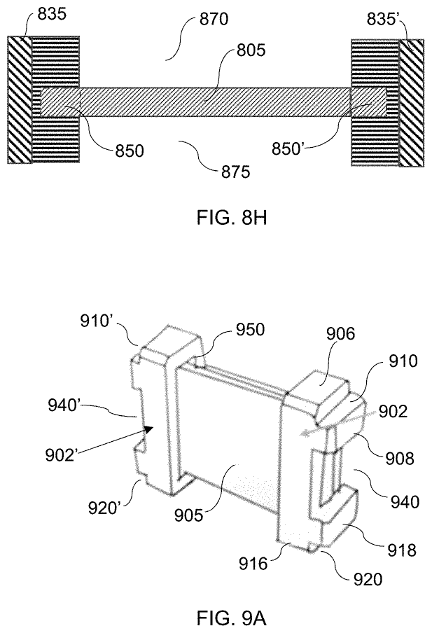

An exemplary two-component insert that mates together to form the cradle cavity is illustrated in FIGS. 8A through 8H. FIG. 8A shows the two-component insert 800 nested together. A top panel 840 includes a first columnar support 825 and a second columnar support 835. The first columnar support 825 and the second columnar support 835 are brought into contact with a surface of the interior of the external protection container when the inserts are placed within the external protection container. The first columnar support 825 and the second columnar support 835 cushion the electronic device 805 from any forces applied to the side of the exterior protection container on which they are located. The first columnar support 825 and the second columnar support 835 can be adjusted to have a desired height in order to yield a central cradle cavity of the desired height.

The top panel 840 includes a first top panel extension 820 is located at one end of the top panel 840, and at the opposite end of the top panel 840 is a second top panel extension. The top panel 840 interlocks with the bottom panel 810, resulting in the formation of a central cradle cavity 850. The central cradle cavity 850 is configured to accept at least a portion of one end of the electronic device to be packaged.

The bottom panel 810 accepts a portion of the first top panel extension 820 in a first cavity, and the second top panel extension 830 in a second cavity, so that the top panel 840 and bottom panel 810 are mated together and lateral movement between the top panel 840 and bottom panel 810 is prevented. An exploded side view showing the first and second cavities is shown in FIG. 8B, and a side view of the conjoined pieces showing how the top extensions interlock within these cavities is shown in FIG. 8C.

In FIG. 8B, a side view of the top panel 840 and bottom panel 810 are shown separated. A second columnar support 835 is attached to the top panel 840. The bottom panel 810 includes a second cavity 816 configured to accept the top panel extension 845. In FIG. 8C, the top panel 840 is brought into contact with the bottom panel 810, and in doing so, top panel extension 845 enters cavity 816, interlocking the top panel 840 and bottom panel 810 together. Alternatively, or in addition thereto, the top panel extensions can be adhered to the bottom panel using a biodegradable adhesive.

FIG. 8D is a front view of the separated top panel 840 and bottom panel 810. The first cavity 815 and second cavity 816 in bottom panel 810 are shown, and each accepts first top panel extension 820 and top panel extension 830, respectively, when the two panels are brought together to form the cornstarch-based foam insert.

FIG. 8E shows a top view looking down on the upper surface of bottom panel 810. The first cavity 815 and second cavity 816 in bottom panel 810 are shown in an exemplary position at each end of bottom panel 810. The position, size and shape of the cavities can be varied, as long as they accommodate the top panel extensions to interlock the bottom panel and top panel together to prevent lateral movement. FIG. 8F shows a top view looking down on the upper surface of top panel 840. The top portions of first columnar support 825 and second columnar support 835 are shown. FIG. 8G shows a bottom view looking up on the lower surface of top panel 840. The top panel extensions 820 and 830 are shown, as well as the top portions of first columnar support 825 and second columnar support 835.

FIG. 8H shows a cutaway of the interlocked top panel and bottom panel forming the cornstarch-based foam inserts with both ends of an electronic device 805 inserted into and supported by central cradle cavities 850 and 850′. The second columnar supports 835 and 835 are positioned on the outer surface and would be placed into contact with an interior surface of the external protection container. Because of the positioning of central cradle cavities 850 and 850′, a top air space 870 is formed above the electronic device 805, and a bottom air space 875 is formed beneath the electronic device 805. These air spaces, in addition to the corner air spaces 310, 320, 330, and 340, side air spaces 315 and 325, front void area 335, and rear void area 345, depicted in FIG. 3B, help to protect the electronic device from shock and stress that typically accompanies shipping and handling, as well as any dropping or mishandling of the package during shipment.

Because the cornstarch foam is resilient and can accommodate compression, the cradle cavity does not need to be shaped to fit the exact contour of the electronic device. Devices having some variance in width or height can be accommodated, and thus the dimensions of the product, and not necessarily its shape or contour configuration, dictate whether or not a given insert could be used. This allows flexibility in packaging, and does not require a different set of inserts for different models of the electronic device having slightly different dimensions. The cornstarch foam insert will be held in place by the external protection container in which the cornstarch foam insert is used.

The insert also can be configured as a single modular side panel. The side panel can be configured to receive a first end of the electronic device when the product is inserted into a cradle cavity within the panel. A second side panel configured to protect the electronic device is configured to receive a second end of the electronic device when the product is inserted into a cradle cavity within the panel. The cradle cavity typically is shaped to conform to the contours of the ends of the electronic device. Because the cornstarch-based foam is resilient, the cradle cavity can accommodate electronic devices of different thicknesses as long as the contour is the same or similar allowing at least a portion of an end of the electronic device to be accommodated in the cradle cavity.

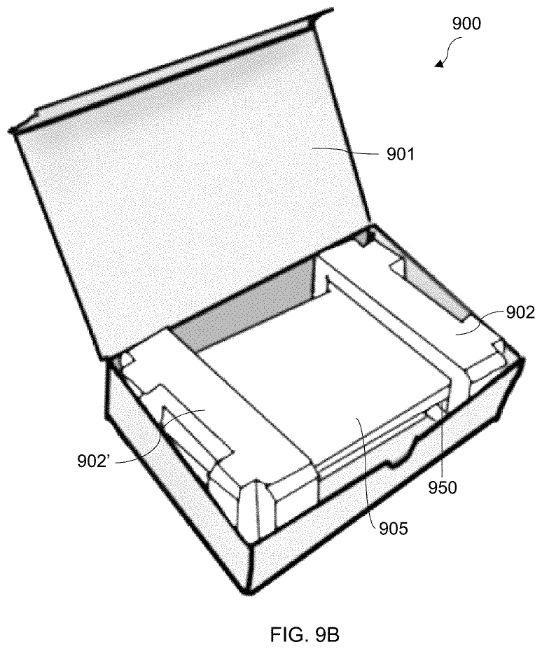

Each modular form corn foam insulation panel can be formed using conventional methods. The modular corn foam insulation panels can include beveled edges to facilitate insertion into and removal from the external protection container. Each of the panels include a central cavity for accepting at least a portion of an end of the electronic device to be packaged. FIGS. 9A and 9B show illustrations of an exemplary embodiment of the packaging system, which includes two modular expanded foam pieces, each containing a cavity 950 forming a cradle in which the electronic device (a laptop is depicted) is supported. In FIG. 9A, a perspective view shows the electronic device 905 inserted into a central cradle cavity 950 of each piece of the modular expanded foam pieces 902 and 902′. Each modular expanded foam piece 902 as depicted includes extensions at each corner that result in the formation of corner air spaces when the inserts cradling the electronic device is placed in the interior of the external protection container. For example, modular expanded foam piece 902 has a first length extension 906 and a first width extension 908 that together result in formation of corner air space 910 when placed in the interior of the external protection container. Modular expanded foam piece 902 also has a second length extension 916 and a second width extension 918 that together result in formation of corner air space 920 when modular expanded foam piece 902 is placed in the interior of the external protection container. The width extensions 908 and 918 form side air space 940 when modular expanded foam piece 902 is placed in the interior of the external protection container. Similar corner air spaces 910′ and 920′ and side air space 940′ are formed at the other side of the electronic device 905 when modular expanded foam piece 902′ is placed in the interior of the external protection container.

FIG. 9B is a perspective view showing the electronic device 905 cradled in the modular expanded foam pieces 902 and 902′ via a central cradle cavity (central cradle cavity 950 in modular expanded foam piece 902 is visible) inserted within the external protection container 901. The corner and side air spaces are visible in FIG. 9B.

The modular expanded foam pieces molded in a shape which receives and cradles at least one end of the electronic device. The molds typically are produced for each electronic device to ensure that the electronic device is tightly cradled. The modular expanded foam inserts can be made by traditional foam production technologies and equipment. For example, the modular expanded foam pieces can be manufactured using Foam Injection Molding (FIM). In some FIM processes, the system is pressurized using nitrogen or carbon dioxide so that the foam can be extruded. Because both of these gases compose Earth's atmosphere, they are not harmful to the environment nor difficult to attain. In using corn foam, the invention provides the optimal internal protection solution for electronic packaging. The foam serves as a desiccant, impact absorber, and anti-static which protects the electronic device from shock and vibration, electrostatic discharge, and humidity.

Similar to injection molding, a fanning agent, typically nitrogen or carbon dioxide, is used to inject the polymer into a barrel when a gas-loaded melt spirals into a mold with the help of a screw. As the screw actuates, gas-loaded melt accumulates at the tip, inevitably allowing for the tip to inject it into a mold in a forward motion. Because the mold typically is in a place having a lower pressure than in the screw extruder, foaming initiates, increasing the foam's volume to fill the mold. Superior dimensional stability and efficient material consumption is attained when FIM is compared to other archetypal molding techniques.

Polylactic Acid Foam Material

In addition to the cornstarch foam insulation described above, the corn foam insulation can contain or be made of polylactic acid (PLA). PLA is a fermentation product that can be produced by fermenting cornstarch. Fermentation, a process seen throughout various sectors of commercial production, is straightforward and can be performed relatively easily. PLA is a thermoplastic, aliphatic polyester derived from renewable resources such as cornstarch and can be used as a compostable packaging material, and can be cast or injection molded. Cornstarch, in its native form or fermented to produce PLA, can undoubtedly replace polystyrene in acting as a foaming agent when using Foam Injection Molding (FIM). FIM is becoming increasingly widespread among foam producers, allowing this invention to utilize current manufacturing methods, without requiring new infrastructure. Originating in the 1960s, FIM has developed into a medium that can generate high strength, lightweight molded foam. Conventionally, polystyrene or polyurethane is utilized as a foam material; however, recently, many companies have utilized organic polylactic acid instead.

Methods for producing PLA are well known in the art (e.g., see WO2004057008 (Teixeira et al., 2004); U.S. Pat. App. Pub. No. US2010/0160597 (Kurihara et al., 2010); U.S. Pat. No. 5,543,494, (Perego et al., 1996); U.S. Pat. No. 9,045,601 (Uehara et al., 2015); and U.S. Pat. No. 9,056,946 (Kishida et al., 2015); and Humphreys, “From Corn to Poly Lactic Acid (PLA): Fermentation in Action,” guest post on Polymer Innovation Blog (Gotro, 2012)). PLA is commercially available from many suppliers, such as NatureWorks LLC (Minnetonka, Minn.).

The PLA foam product can be used to produce foam inserts as described above for the production of extruded cornstarch foam inserts. The PLA foam product can be used to produce two-component inserts as described above for the extruded cornstarch foam inserts. The PLA foam product can be used to produce modular expanded foam pieces using the same or similar methods and techniques described above for preparation of modular extruded cornstarch foam inserts. The PLA foam can include a green dye to indicate that the PLA foam is biodegradable or compostable.

4. Modeling

Computer simulations were conducted to test the external protection container and optimize material usage to achieve a packaging system that can withstand the customary impact associated with shipping and handling. These simulations allowed for the identification of certain pressure points that were used during design and fabrication. The static stress test showcased whether the external protection container would morph upon contact with the ground or when external forces are present or applied. Some anticipated forces include those from beneath when the external protection container descends, whether it be during the formal three-foot drop test or during shipment, and forces from above, in the case where additional boxes are stacked on top of the external protection container. The tests identified the location of these pressure points and whether the corn-based foam insulation (whether cornstarch foam insulation of PLA foam insulation) and the external protection container were absorbing the impulse upon collision, designed for the corn-based foam insulation to absorb or dissipate the majority of the vertical force. A static stress analysis test also was used to determine the condition of the external protection container following a descent. This was done to determine whether corn-based foam insulation was truly necessary in certain places; for example, if the external protection container could withstand the impact, then the foam would be removed in order to optimize the usage of materials by minimizing the inclusion of unnecessary corn-based foam insulation. After running these tests numerous times, it was determined that corn-based foam insulation only was needed at each end of the electronic device as support to cradle the electronic device and create air spaces around the electronic device as described above, because of the strength of the laminate comprising the wheat straw paper composite provided herein.

The drop tests examined the effect of falls from different heights on the wheat straw paper external protection container as well as the electronic device contained therewithin. Following drops from approximately three feet above the ground, a laptop computer and its charger from within the wheat straw paper external protection container were tested. Both were found to function properly following the drop tests. To ensure that the packaging system that includes the wheat straw paper external protection container and a cornstarch foam insert was comprehensively functional in terms of sustainability and durability; and whether the packaging system would sustain the underlying handling and hustling of a shipment, a packaging system including the wheat straw paper composite external protection container and cornstarch corn foam insulation cradling a computer laptop were dropped from a rooftop (approximately 12 feet from the ground). Testing after the drop test from this height demonstrated that the integrity of the computer remained the same, indicating that the packaging system provided herein including a wheat straw paper external protection container and a cornstarch foam insert exhibits exceptional strength and durability.

While the present invention has been described above with reference to the exemplary embodiments, and while the embodiments have been described in considerable detail, it is not intended to restrict or in any way limit the scope of the appended claims to such detail. It can be understood by those skilled in the art that the present invention can be variously modified and changed without departing from the spirit and scope of the present invention disclosed in the claims.

### C. Reference Signs List

The following is a listing of the reference numerals used in the description and the accompanying Drawings.
1 external protection container
2 corn foam insulation
11 flute of corrugated material
21 void space within corn foam insulation
22 void space within corn foam insulation
23 void space within corn foam insulation
24 space
25 space
26 space
50 cradle cavity
200 exemplary packaging system
201 external protection container
205 electronic device
210 first corn foam insulation insert
215 first columnar support
217 second corn foam insulation insert
220 first corn foam insulation insert
225 first columnar support
227 second columnar support
250 cradle cavity
251 cradle cavity
260 power cord
265 power adapter
300 exemplary packaging system
301 external protection container
302 first corn foam insulation insert
303 second corn foam insulation insert
305 electronic device
310 first corner air space
315 first side air space
320 second corner air space
325 front void area
330 rear void area
335 third corner air space
340 second side air space
345 fourth corner air space
350 cradle cavity
400 wheat straw paper composite
410 first layer of wheat straw paper
411 first surface of wheat straw paper 410
412 second surface of wheat straw paper 410
420 second layer of wheat straw paper
421 first surface of wheat straw paper 420
422 second surface of wheat straw paper 420
450 wheat flour film
451 first surface of wheat flour film 450
452 second surface of wheat flour film 450
500 laminate
510 first wheat straw paper composite flat sheet
511 flute
520 corrugated wheat straw paper composite
530 second wheat straw paper composite flat sheet
800 two-component corn foam insulation insert
805 electronic device
810 bottom panel
815 first cavity
816 second cavity
820 first top extension
825 first columnar support
830 second top extension
835 second columnar support
840 top panel
845 extension of top panel 840
850 central cradle cavity
870 top air space
875 bottom air space
900 exemplary packaging system
901 external protection container
902 modular expanded foam piece
902′ modular expanded foam piece
905 electronic device
906 first length extension
908 first width extension
910 corner air space
910′ corner air space
916 second length extension
918 second width extension
920 corner air space
920′ corner air space
940 side air space
940′ side air space
950 central cradle cavity

What is claimed is:

1. A wheat straw paper composite for a packaging material, comprising:
a first layer of wheat straw paper;
a layer of wheat flour film in contact with a surface of the first layer of wheat straw paper; and
a second layer of wheat straw paper in contact with a surface of the wheat flour film opposite of the surface of the layer of wheat flour film in contact with the first layer of wheat straw paper.

2. The wheat straw paper composite of claim 1, wherein the wheat straw paper comprises unbleached wheat straw fiber.

3. The wheat straw paper composite of claim 2, wherein the wheat straw paper comprises at least 80 wt % virgin wheat straw fiber.

4. The wheat straw paper composite of claim 2, wherein the wheat straw paper comprises up to 20 wt % agricultural fiber selected from among abaca, bamboo, corn husk fiber, corn stalk fiber, cotton, flax, hemp, jute, kenaf, rice straw fiber, recycled wheat straw fiber, sisal fiber, sugarcane bagasse fiber, and combinations thereof.

5. The wheat straw paper composite of claim 2, wherein the wheat straw paper comprises an additive selected from among a filler, a fire retardant, an impact modifier, a plasticizer, a processing aid, a UV stabilizer, a mineral particle for hardness, and combinations thereof.

6. The wheat straw paper composite of claim 2, wherein the wheat straw paper has a basis weight of from about 75 g/m² to 450 g/m².

7. The wheat straw paper composite of claim 2, wherein the wheat flour film is a dried aqueous solution containing a gelatinized wheat flour.

8. The wheat straw paper composite of claim 7, wherein the wheat flour comprises at least 8 wt % total protein.

9. The wheat straw paper composite of claim 7, wherein the wheat flour comprises from about 8 wt % to about 15 wt % protein total protein.

10. The wheat straw paper composite of claim 7, wherein the wheat flour comprises from about 1 to 4 wt % gliadins.

11. The wheat straw paper composite of claim 7, wherein the wheat flour comprises from about 4 to 6 wt % glutenins.

12. The wheat straw paper composite of claim 7, wherein the wheat flour yields an amount of gluten when the wheat flour is moistened or exposed to an aqueous solution and subjected to shear energy is from about 8 to 13 wt % gluten.

13. The wheat straw paper composite of claim 7, wherein the aqueous solution comprises an amount of wheat flour from about 5 wt % to about 15 wt % based on the total weight of the aqueous solution.

14. A packaging system, comprising:
a combination of an external protection container and a corn foam insulation insert, wherein:
the external protection container comprises a laminate comprising:
at least three wheat straw paper composites of claim 1:
a first wheat straw paper composite in the form of a flat sheet;
a second wheat straw paper composite in the form of a flat sheet;
a corrugated sheet comprising a third wheat straw paper composite corrugated to include a plurality of flutes and having a first surface and a second surface; and
the corn foam insert comprises:
a biodegradable cornstarch foam product comprising at least 60 wt % cornstarch; or
a biodegradable expanded foam comprising a polylactic acid (PLA).

15. The packaging system of claim 14, further comprising:
a first layer of a biodegradable adhesive between the first surface of the corrugated sheet and the first wheat straw paper composite; and
a second layer of a biodegradable adhesive between the second surface of the corrugated sheet and the second wheat straw paper composite.

16. The packaging system of claim 15, wherein:
the biodegradable adhesive in the first layer and the second layer is the same; or
the biodegradable adhesive in the first layer is different from the biodegradable adhesive in the second layer.

17. The packaging system of claim 14, further comprising:
a first wheat flour film between the first surface of the corrugated sheet and a surface of the first wheat straw paper composite; and
a second wheat flour film between the second surface of the corrugated sheet and a surface of the second wheat straw paper composite.

18. The packaging system of claim 14, wherein the corn foam insert comprises a biodegradable cornstarch foam product that is an extruded product comprising at least 90 wt % cornstarch, and the biodegradable cornstarch foam product has a medium density, closed cell structure.

19. The packaging system of claim 18, wherein the cornstarch is a modified cornstarch selected from among an acid treated starch, an enzymatically modified starch, an alkali treated starch, a dextrinized starch, a hydroxymethylated starch, a hydroxyethylated starch, a hydroxypropylated starch, an octenyl succinic anhydride modified starch, a starch acetate, a starch phosphate, an oxidized starch, an acetylated oxidized starch, and combinations thereof.

20. The packaging system of claim 14, wherein the corn foam insert comprises polylactic acid (PLA).
